(19) United States
(12) Patent Application Publication
(10) Pub. No.: US 2026/0012737 A1
(43) Pub. Date: Jan. 8, 2026

(54) HEARING DEVICE WITH MULTI-PART BATTERY MODULE

(71) Applicant: GN Hearing A/S, Ballerup (DK)

(72) Inventors: Anders Hjermø MICHAELSEN, Bagsværd (DK); Henrik NIELSEN, Roskilde (DK)

(73) Assignee: GN Hearing A/S, Ballerup (DK)

(21) Appl. No.: 19/256,173

(22) Filed: Jul. 1, 2025

(30) Foreign Application Priority Data
Jul. 5, 2024 (EP) 24186870.2

(51) Int. Cl. H04R 25/00

(52) U.S. Cl. CPC H04R 25/602; H04R 25/609; H04R 2225/31

(57) ABSTRACT

A hearing device is disclosed. The hearing device comprises a hearing device module and a battery module. The hearing device module comprises a housing forming at least a part of an outer surface of the hearing device. The hearing device comprises a frame. The hearing device comprises a battery compartment. The battery module is arranged in the battery compartment, the battery module comprising a plurality of parts including a first part configured to engage with the hearing device module for securing the battery module in the battery compartment.

### RELATED APPLICATION DATA

This application claims priority to, and the benefit of, European Patent Application No. 24186870.2 filed on Jul. 5, 2024. The entire disclosure of the above application is expressly incorporated by reference herein.

### FIELD

The present disclosure relates to a hearing device and a related method.

### BACKGROUND

Developments in the hearing aid industry require the ability for independent service providers or end users to exchange a rechargeable battery. This requirement may introduce various challenges due to the compact nature and tight spatial constraints which are intrinsic to hearing devices, such as Behind-the-Ear, BTE, hearing devices and Receiver-In-Ear, RIE, hearing devices.

### SUMMARY

Accordingly, there is a need for hearing devices with increased design freedom and flexibility in the selection of power source.

A hearing device is disclosed, the hearing device comprising a hearing device module and a battery module, the hearing device module comprising a housing forming at least a part of an outer surface of the hearing device. The hearing device comprises a frame and a battery compartment. The battery module is arranged in the battery compartment, the battery module comprising one or more, such as a plurality of, parts including a first part configured to engage with the hearing device module, e.g., for securing the battery module in the battery compartment.

A method of assembling a hearing device comprising a hearing device module and a battery module is disclosed. The method comprises selecting the battery module from a set of battery modules comprising a first battery module and a second battery module. The first battery module optionally comprises a rechargeable battery. The second battery module is optionally configured to accommodate a single-use, or disposable, battery, such as a zinc-air battery. The method comprises mounting the battery module to the hearing device module.

The disclosed method and hearing device provide modularity and/or simplicity in the hearing device design and advantageously enables an improved efficiency and/or reduced cost of the assembly and/or manufacturing process of the hearing device. In other words, the disclosed hearing device and related method enables a reduced complexity in the assembly/manufacturing process as common parts such as a hearing device module may be used for different types of hearing device, such as different types of batteries/battery modules of the hearing device.

Further, the present disclosure allows for an independent service provider and/or an end user of the hearing device to perform a battery change in such a way that the quality and functionality of the hearing aid after the replacement is on par with a new hearing aid.

Further, increased design flexibility for the hearing device is provided.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates a cross section of a portion of an example hearing device,

FIG. 2 schematically illustrates part of an example hearing device module,

FIG. 3A schematically illustrates a first part of an example battery module of a first type,

FIG. 3B schematically illustrates a second part of a battery module of a first type,

FIG. 3C schematically illustrates connecting parts of a battery module of a first type,

FIG. 4A schematically illustrates a battery module of a second type in a closed position,

FIG. 4B schematically illustrates a battery module of a second type in an open position, and

FIG. 5 is a flow chart illustrating an example method of assembling a hearing device according to this disclosure.

### DETAILED DESCRIPTION

Various exemplary embodiments and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device is disclosed. The hearing device may be configured to be worn at an ear of a user and may be a hearable or a hearing aid, wherein the processor is configured to compensate for a hearing loss of a user.

The hearing device may be of the behind-the-ear (BTE) type, in-the-ear (ITE) type, in-the-canal (ITC) type, receiver-in-canal (RIC) type or receiver-in-the-ear (RITE) type. The hearing device may be a binaural hearing device. The hearing device may comprise a first earpiece and a second earpiece, wherein the first earpiece and/or the second earpiece is an earpiece as disclosed herein.

A hearing device and related method is disclosed, the hearing device comprising a hearing device module and a battery module, the hearing device module comprising a housing forming at least a part of an outer surface of the hearing device. The housing may comprise one or more shell parts or outer parts.

The hearing device module comprises a frame arranged in the housing. The frame may be configured to carry a printed circuit board, PCB, such as flexible PCB. In other words, the PCB or PCBA of the hearing device module also denoted first PCB may be mounted on the frame. One or more electric components of the hearing device, such as one or more of processor, radio transceiver, power module, and microphone(s) may be mounted on the PCB, e.g. for forming a PCBA. In one or more examples, the housing, such as one or more shell parts of the housing, may be mounted on the frame.

The hearing device module comprises a battery compartment. The battery compartment is configured to accommodate, e.g. fully or at least partly, a battery module. The hearing device module, such as one or more of the battery compartment, the frame, and the first PCB, comprises an electrical interface, e.g. comprising one or more terminals. The electrical interface forms electrical connection to the battery module when the battery module is mounted in the battery compartment. The electrical interface may be arranged on the first PCB. The electrical interface may comprise one or more power terminals, such as a first power terminal and/or a second power terminal. The electrical interface may comprise one or more control terminals, such as a first control terminal and/or a second control terminal. The battery compartment/electrical interface may comprise a ground terminal. The terminal(s) of the electrical interface are for example configured to electrically connect terminals of the battery module, such as anode or ground/minus, cathode or power/plus, and optionally one or more controls of the battery module, to the respective terminals when the battery module is inserted and/or accommodated in the battery compartment.

The hearing device may be configured for wireless communication with one or more devices, such as with another hearing device, e.g. as part of a binaural hearing system, and/or with one or more accessory devices, such as a smartphone and/or a smart watch. The hearing device optionally comprises an antenna for converting one or more wireless input signals, e.g. a first wireless input signal and/or a second wireless input signal, to antenna output signal(s). The wireless input signal(s) may originate from external source(s), such as spouse microphone device(s), wireless TV audio transmitter, and/or a distributed microphone array associated with a wireless transmitter. The wireless input signal(s) may originate from another hearing device, e.g. as part of a binaural hearing system, and/or from one or more accessory devices.

The hearing device optionally comprises a radio transceiver coupled to the antenna for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device may comprise a plurality of antennas and/or an antenna may be configured to be operate in one or a plurality of antenna modes. The transceiver input signal optionally comprises a first transceiver input signal representative of the first wireless signal from a first external source.

The hearing device comprises a set of microphones. The set of microphones may comprise one or more microphones. The set of microphones comprises a first microphone for provision of a first microphone input signal and/or a second microphone for provision of a second microphone input signal. The set of microphones may comprise N microphones for provision of N microphone signals, wherein N is an integer in the range from 1 to 10. In one or more exemplary hearing devices, the number N of microphones is two, three, four, five or more. The set of microphones may comprise a third microphone for provision of a third microphone input signal.

The hearing device comprises a processor for processing input signals from the microphone(s) and/or the radio transceiver. The processor provides an electrical output signal based on the input signals to the processor. Input terminal(s) of the processor are optionally connected to respective output terminals of the microphone(s) and/or the radio transceiver.

The hearing device comprises a processor for processing input signals, such as transceiver input signal(s) and/or microphone input signal(s). The processor is optionally configured to compensate for hearing loss of a user of the hearing device. The processor provides an electrical output signal based on the input signals to the processor.

A hearing device is disclosed, the hearing device comprising a hearing device module and a battery module. The hearing device module comprises a housing forming at least a part of an outer surface of the hearing device; a frame; and a battery compartment.

The battery module is arranged in the battery compartment of the hearing device module, the battery module comprising one or a plurality of parts including a first part configured to engage with, such as electronically and/or mechanically engage with or couple to, the hearing device module, e.g. for securing the battery module in the battery compartment.

In one or more examples, a hearing device comprising a hearing device module and a battery module is provided, the hearing device module comprising a housing forming at least a part of an outer surface of the hearing device; a frame; and a battery compartment, wherein the battery module is arranged in the battery compartment, the battery module comprising a plurality of parts including a first part configured to engage with the hearing device module for securing the battery module in the battery compartment.

The housing may for example be a BTE housing, an ITE housing, an ITC housing, an RIC housing, or an RITE housing. The housing may be a single-part or a multipart housing, e.g. comprising one or more shell-parts. A shell-part forms a part of the outer surface of the hearing device module. A single-part housing may reduce the risk of moisture entering the inner space of the hearing device. A multi-part housing may facilitate, e.g. simplify, assembly.

The frame can be seen as at least a part or chassis of the hearing device configured for attachment and/or fixing of components of the hearing device. Components and/or circuitry of the hearing device optionally comprise one or more of: receiver, microphone(s), processor, first printed circuit board (PCB), first printed circuit board assembly, etc. and can for example be mounted on the frame.

The battery compartment can for example be seen as accommodating, e.g. fully or at least partly, the battery module. For example, the battery compartment may be seen as a compartment within which the battery module and/or the battery, such as a rechargeable, replaceable battery, is located.

The hearing device comprises a battery module comprising one or a plurality of parts including a first part and optionally a second part.

The first part of the battery module may be configured to engage with and/or attach to the frame and/or the housing. In one or more examples, the first part is configured to mechanically engage, such as via one or more of a press-fit, a snap-lock, and a pin lock, with the frame/housing. In one or more examples, the first part is glued, soldered, or otherwise adhesively secured to the frame and/or housing. A combination of mechanical securing and adhesively securing the first part to the frame and/or housing may be implemented.

In one or more example hearing devices, the battery compartment is configured to receive, e.g. in a first configuration, a battery module of a first type and, e.g. in a second configuration, a battery module of a second type.

A battery module of the first type also denoted first battery module may be a battery module comprising a rechargeable battery.

A battery module of the second type also denoted second battery module may be a battery module comprising or configured to accommodate a disposable single-use battery, such as a zinc-air battery.

In one or more example hearing devices, the battery module, such as a battery module of the second type, comprises a first battery terminal and a second battery terminal, e.g. for electrically connecting a battery of the battery module to the hearing device module. The battery module, such as a battery module of the second type, optionally comprises a third battery terminal, e.g. for electrically connecting a battery of the battery module to the hearing device module.

In one or more example hearing devices, the first part comprises a first supply terminal and/or a second supply terminal for connecting to the electrical interface of the hearing device module.

The first supply terminal of the first part may be a power terminal, e.g. configured to electrically connect to, e.g. by galvanic contact, a first power terminal, e.g. for a battery module of a first type, or a second power terminal, e.g. for a battery module of a second type, of the electrical interface of the hearing device module. In other words, a first supply terminal of the first battery module may be configured to connect to a different power terminal of a hearing device module than a first supply terminal of the second battery module.

The second supply terminal of the first part may be a ground terminal, e.g. configured to electrically connect to, e.g. by galvanic contact, a ground of the electrical interface of the hearing device module.

In one or more example hearing devices, the first part comprises a first control terminal and/or a second control terminal for connecting to an electrical interface, such as respective first control terminal and/or second control terminal, of the hearing device module.

Terminals of the electrical interface and terminals of the first part of the battery module may be soldered, glued, press-fitted, and/or welded together for forming galvanic connections therebetween.

In one or more example hearing devices, the hearing device module comprises a printed circuit board also denoted first PCB, e.g. attached to the frame, wherein the electrical interface, such as one or more terminals, is arranged on the printed circuit board, e.g. as PCB soldering pads.

In one or more example hearing devices, the hearing device module comprises a battery module connector, e.g. attached to the frame and/or first PCB, wherein the electrical interface, such as one or more terminals, is arranged in or on the connector.

In one or more example hearing devices, the electrical interface comprises a first power terminal for the first type of battery module and a second power terminal for the second type of battery module. The first power terminal may be configured for powering the hearing device module with a battery module of the first type also denoted first battery module and/or the second power terminal may be configured for powering the hearing device module with a battery module of the second type also denoted second battery module. The first power terminal may be configured for a first supply voltage. The first supply voltage may be larger than 3.0V. The second power terminal may be configured for a second supply voltage different from, such as less than or larger than, the first supply voltage. The second supply voltage may be less than 3.0V.

In one or more examples, the battery module comprises a second part. The second part optionally forms a battery door. The second part, e.g. in a battery module of the second type, may be pivotably connected to the first part, e.g. via a pin and respective first pin opening and second pin opening of the first part and the second part. The second part may form a part of the outer surface of the hearing device. The second part may be configured to accommodate, such as hold, a battery or battery unit.

In one or more example hearing devices, the battery module comprises a second part forming a battery door and connecting the second part pivotably to the first part.

The battery module may comprise a rechargeable battery e.g. accommodated in the second part.

The first part of the battery module may comprise a power module. The power module may comprise an induction coil configured to harvest power, e.g. from a wireless charging device. The power module is optionally configured to apply a charging voltage to a rechargeable battery accommodated in or forming part of the battery module. In other words, the power module may be configured to apply a charging voltage to a rechargeable battery of the second part. The power module may comprise or be implemented in a second PCBA. In other words, the power module of the first part may comprise a second PCB having one or more components mounted thereto.

In one or more example hearing devices, the battery module comprises a rechargeable battery, and the first part of the battery module comprises a power module configured to apply a charging voltage to or charge the rechargeable battery.

The first part of the battery module may comprise the first battery terminal and/or the second battery terminal. In one or more examples, the second part of the battery module comprises the first battery terminal and/or the second battery terminal. The first part of the battery module may comprise a first connector. The second part of the battery module may comprise a second connector. The second connector may be configured to connect with the first connector for forming electric and/or mechanical connection between the first part and the second part of the battery module.

The first battery terminal may be configured to contact a surface or first connector element of the battery or battery unit, when the battery or battery unit is inserted in the battery module.

The second battery terminal may be configured to contact a surface or second connector element of the battery or battery unit, when the battery or battery unit is inserted in the battery module.

In one or more example hearing devices, the first part of the battery module comprises a first connector, and the battery module comprises a second part comprising a second connector configured to connect with the first connector for forming electric and/or mechanical connection between the first part and the second part of the battery module.

In one or more example hearing devices, the second part of the battery module forms an outer surface of the hearing device.

A method of assembling a hearing device comprising a hearing device module and a battery module is disclosed. The method comprises selecting the battery module from a set of battery modules comprising a first battery module and a second battery module. The first battery module comprises a rechargeable battery. The second battery module is configured to accommodate a disposable, single-use battery. The method comprises mounting the battery module to the hearing device module.

In other words, mounting the battery module to the hearing device module comprises mounting the selected battery module, such as the first battery module or the second battery module, to the hearing device module.

In one or more example methods, mounting the battery module to the hearing device module comprises connecting a first supply terminal and a second supply terminal of the battery module to an electric interface of the hearing device module.

The battery terminals, such as the first battery terminal and/or the second battery terminal of the hearing device, may be configured to connect the battery/battery unit arranged in the battery compartment/battery module to a power terminal, such as the first power terminal and/or the second power terminal, and/or a ground terminal and/or other electric components of the hearing device, e.g. via conductors, such as traces of PCB and/or wires, such as litz wires. One or more of the battery terminals may comprise metallic spring members.

In one or more examples, the hearing device, such as the first part of the battery module, comprises a power module configured to provide a charging voltage to charge the rechargeable battery. The power module is optionally connected to the battery or battery unit via the first battery terminal, the second battery terminal, and optionally via a third battery terminal.

In one or more examples, the hearing device, such as the hearing device module has a battery opening in the outer surface, and the hearing device, such as the battery module, comprising a battery lid configured to open or close the battery opening. The battery lid may also be referred to as a battery door.

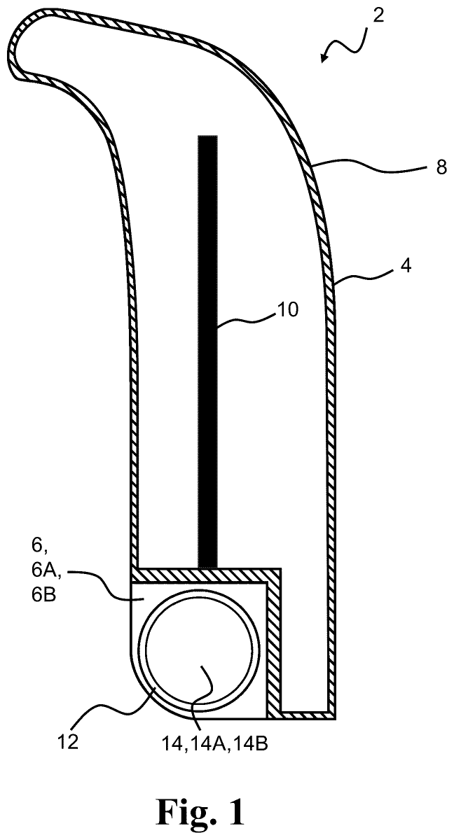

FIG. 1 shows a schematic side cross sectional view of an example hearing device 2. The hearing device 2 comprises a hearing device module 4 and a battery module 6, such as battery module 6A or battery module 6B described in further detail later, the hearing device module 4 comprising a housing 8 forming at least a part of an outer surface of the hearing device 2; a frame 10; and a battery compartment 12. The battery module 6 is arranged in the battery compartment 12 of the hearing device module 4, the battery module 6 comprising or is configured to accommodate a battery 14 also denoted battery unit. The battery module 6 comprises one or a plurality of parts including a first part (not shown in FIG. 1 but otherwise referred to with reference number 16 and 16A) configured to engage with the hearing device module 4 for securing the battery module 6 in the battery compartment 12.

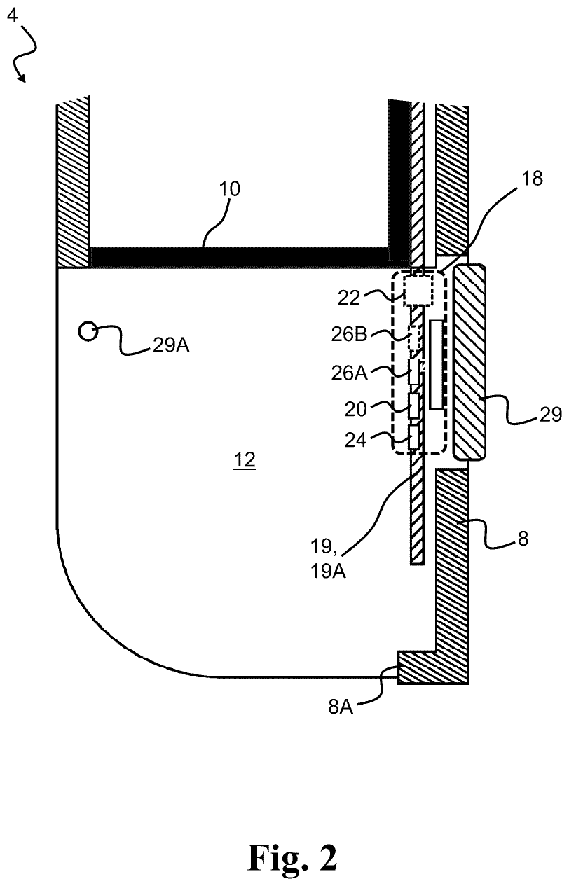

FIG. 2 shows a schematic side cross sectional view of a part of hearing device module 4. The hearing device module 4 comprises a housing 8 forming at least a part of an outer surface of the hearing device 2; a frame 10; and a battery compartment 12. The battery compartment 12 is configured to accommodate a battery module (not shown). The hearing device module comprises an electrical interface indicated with dotted line 18 and arranged on a (first) printed circuit board PCB 19 or (first) printed circuit board assembly PCBA 19A, the electrical interface 18 comprising one or both of a first power terminal 20 and second power terminal 22. The first power terminal 20 may be configured for a first supply voltage e.g. larger than 3.0V, such as in the range from 4.0V to 5.0V. The second power terminal 22 may be configured for a second supply voltage different from the first supply voltage, e.g. less than 3.0V, such as in the range from 1.0V to 2.0V.

The electrical interface 18 comprises ground terminal 24 and optionally first control terminal 26A. In one or more examples, the electrical interface 18 comprises a second control terminal 26B. Optionally, the hearing device module comprises a button 29 as part of a user interface of the hearing device. Control terminals 26A, 26B may be connected to control circuitry, e.g. of processor, of the hearing device module.

Pin hole 29A of the housing 8 allows locking of a battery module in the battery compartment 12. The housing 8 optionally comprises end part 8A which may be configured to assist in locking or fixing the battery module in the battery compartment 12.

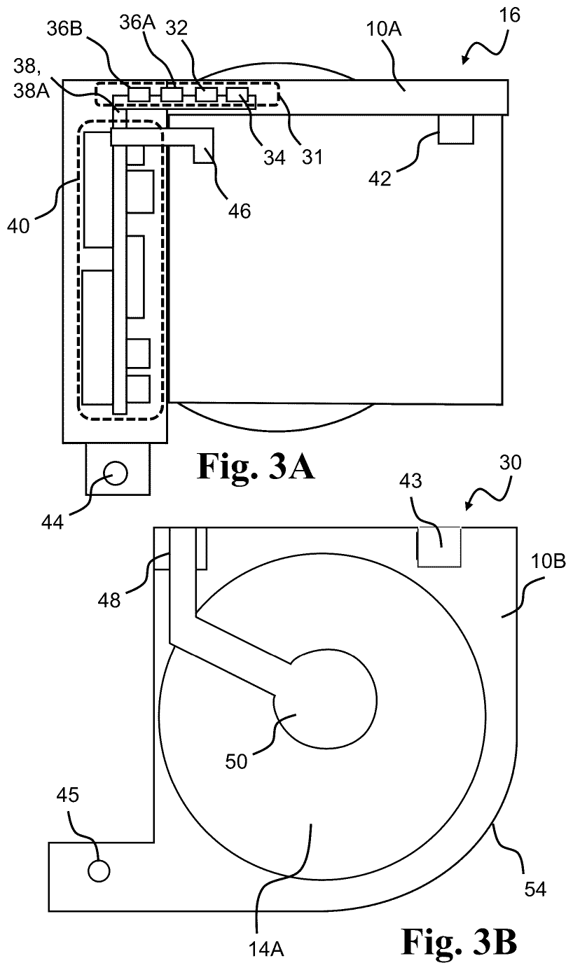

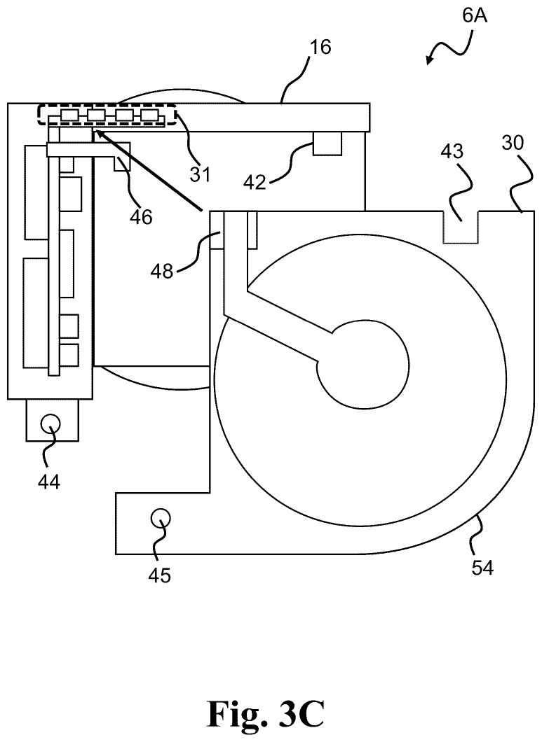

FIG. 3A illustrates an example first part 16 of a battery module, e.g. of a first type. The first part 16 of the battery module comprises an electrical interface indicated with dotted line 31 and comprising a first supply terminal 32 being a power terminal configured to electrically connect to the first power terminal 20 of the hearing device module 4/electric interface 18.

The first part 16 comprises a second supply terminal 34 being a ground terminal configured to electrically connect to the ground terminal 24 of the hearing device module 4/electric interface 18.

The first part 16 optionally comprises a first control terminal 36A and/or a second control terminal 36B for connecting to respective first control terminal 26A and second control terminal 26A of the hearing device module 4/electrical interface 18.

The first part 16 comprises a second PCB 38 with the electrical interface 31 arranged on the (second) printed circuit board PCB 38 or (second) printed circuit board assembly PCBA 38. The first part 16 comprises a power module 40 with components arranged on the second PCB 38. The power module 40 is configured to apply a charging voltage to a rechargeable battery arranged in the second part 30 shown in FIG. 3B. The first part 16 comprises first engagement member 42 formed as a protrusion and configured to engage a corresponding second engagement member 43, such as a recess, of the second part, see FIG. 3B. The first part 16 comprises a first pin hole 44, which in assembled position aligns with pin hole 29A of the housing 8 for locking the first part to the hearing device module 4 with a pin and/or for locking and/or pivotably coupling the first part 16 to the second part 30 via a corresponding second pin hole 45, see FIG. 3B.

The first part 16 comprises a first connector 46 for electrically and optionally mechanically connecting the first part 16, such as first supply terminal 32, to the second part 30 via a corresponding second connector 48, see FIG. 3B.

FIG. 3B illustrates an example second part 30 of a battery module, e.g. of a first type. The first part 16 of FIG. 3A and the second part 30 of FIG. 3B may form a first battery module 6A. The second part 30 of battery module 6A comprises a rechargeable battery 14A connected to first battery terminal 50 and second battery terminal (not shown). The second connector 48 is connected to the first battery terminal 50 for forming electrical connection between the first power terminal 20 and the first battery terminal 50 via the first supply terminal 32, the first connector 46, and the second connector 48. The power module 40 of the first part 16 is configured to apply a charging voltage to the rechargeable battery 14A via the first battery terminal 50 and the second battery terminal. Further, the rechargeable battery 14A is configured to apply a voltage to first power terminal 20 and ground terminal 24 via first electrical connection from the first battery terminal 50 to the first power terminal 20 via connectors 46, 48 and the first supply terminal 32.

The second part 30 forms an outer surface 54 of the hearing device, such as an outer surface of the hearing device disclosed herein.

FIG. 3C illustrates connecting a second part 30 to a first part 16 of battery module 6A of the. During connection, the second part 30 of the battery module 6A is moved in the direction of the arrow such that the first connector 46 electrically connects to the second connector 48, the first pin hole 44 is aligned with the second pin hole 45, and the first engagement member 42 engages the second engagement member 43. A pin inserted in the first pin hole 44 and the second pin hole 45 locks the second part 30 to the first part 16. When the battery module 6A is inserted into battery compartment 12 of hearing device module 4, the electrical interface 31 couples to and makes contact to the electrical interface 18 in such a way that the first supply terminal 32 makes contact with the first power terminal 20, the second supply terminal 34 makes contact with the ground terminal 24, the first control terminal 36 makes contact with the first control terminal 26, and the second control terminal 38 makes contact with the first control terminal 28. In this way, the hearing device 2 may receive power from the battery module 6A, and e.g. monitor a selected set of conditions pertaining to the battery 14A and/or power module 40 via the control terminals 26, 28, such as temperature, remaining battery charge, voltage level, number of charge cycles, charge control, etc.

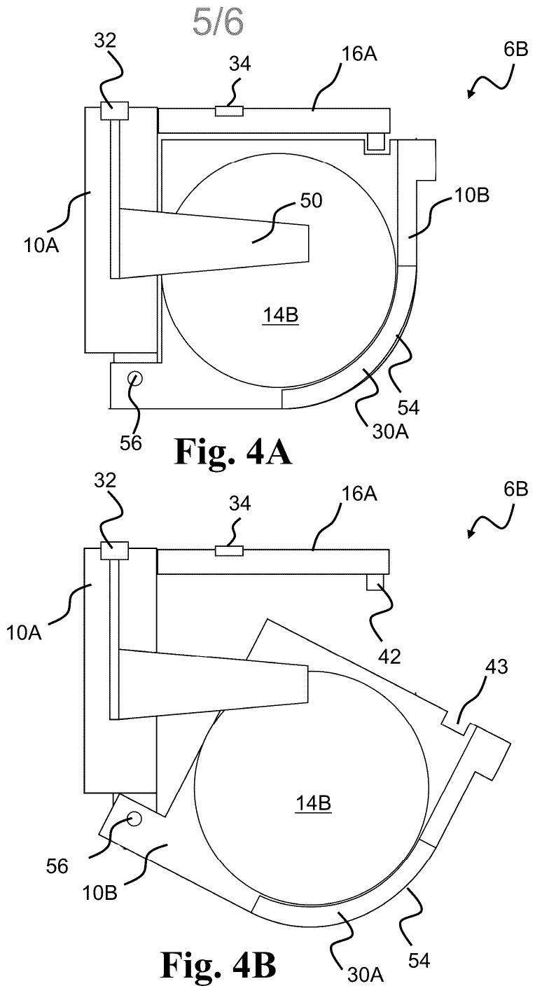

FIG. 4A illustrates an example battery module 6B for holding a disposable battery 14B, such as a zinc-air type battery. The battery module 6B is of a second type and comprises a first part 16A and a second part 30A.

The first part 16A comprises a first battery terminal 50 configured to connect to the second power terminal 22 of the hearing device module 4 via first power terminal 32 of the first part 16A. A second battery terminal (not shown) is configured to connect to the ground terminal 24 of the hearing device module 4 via second power terminal 34 of the first part 16A.

The second part 30A forms a battery door and is configured to accommodate a battery such as a disposable, single-use battery 14B. The second part 30A is pivotably connected to the first part 16A via pin connection 56. The pin connection may also form a lock connection between the first part 16A and the hearing device module 4. FIG. 4A shows the second part 30A with the battery door in a closed position, the battery 14B making contact with first battery terminal 50 and second battery terminal, respectively, for powering the hearing device module 4 via second power terminal 22 and ground terminal 24 of electric interface 18.

FIG. 4B illustrates the example battery module 6B with the second part 30A/battery door in an open or semi-open position. In the open position, the battery 14B is disconnected from the battery terminals thereby disrupting power to the hearing device circuitry when the battery door is open. Upon further opening of the second part 30A, the battery 14B can be replaced. The engagement member 42, 43 forms a click-connection between the first part 16A and the second part 30A.

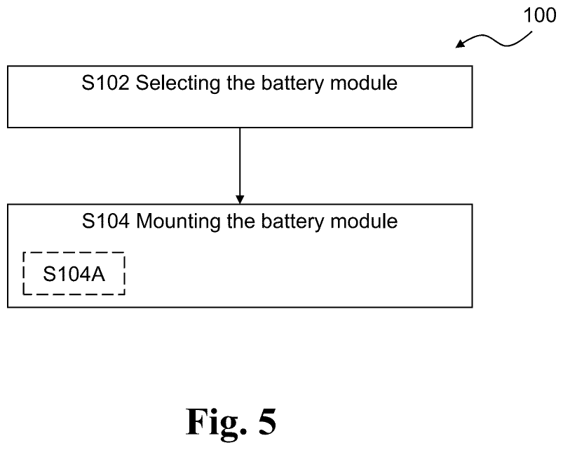

FIG. 5 is a flow diagram of an example method 100 of assembling a hearing device comprising a hearing device module and a battery module, such as the hearing device disclosed herein. The method 100 comprises selecting S102 the battery module from a set of battery modules comprising a first battery module and a second battery module, the first battery module comprising a rechargeable battery, and the second battery module configured to accommodate a single-use battery. The method 100 comprises mounting S104 the battery module to the hearing device.

In one or more example methods, mounting S104 the battery module to the hearing device module comprises connecting S104A a first supply terminal and a second supply terminal of the battery module to an electric interface of the hearing device module.

Disclosed are hearing devices and methods according to any one of the following items
Item 1. A hearing device comprising a hearing device module and a battery module, the hearing device module comprising:
   a housing forming at least a part of an outer surface of the hearing device;
   a frame; and
   a battery compartment,
wherein the battery module is arranged in the battery compartment, the battery module comprising a plurality of parts including a first part configured to engage with the hearing device module for securing the battery module in the battery compartment.
Item 2. Hearing device according to Item 1, wherein the battery compartment is configured to receive a battery module of a first type and a battery module of a second type.
Item 3. Hearing device according to any one of Items 1-2, wherein the battery module comprises a first battery terminal and a second battery terminal.
Item 4. Hearing device according to any one of Items 1-3, wherein the first part comprises a first supply terminal and a second supply terminal for connecting to an electrical interface of the hearing device module.
Item 5. Hearing device according to Item 4, the hearing device module comprising a printed circuit board attached to the frame, wherein the electrical interface is arranged on the printed circuit board.
Item 6. Hearing device according to any one of Items 4-5, wherein the electrical interface comprises a first power terminal for the first type of battery module and a second power terminal for the second type of battery module.
Item 7. Hearing device according to any one of Items 1-6, wherein the battery module comprises a second part forming a battery door and connecting the second part hingeably to the first part.
Item 8. Hearing device according to any one of Items 1-7, wherein the battery module comprises a rechargeable battery, and the first part of the battery module comprises a power module configured to apply a charging voltage to the rechargeable battery.
Item 9. Hearing device according to Item 8, wherein the first part of the battery module comprises a first connector, and the battery module comprises a second part comprising a second connector configured to connect with the first connector for forming electric and/or mechanical connection between the first part and the second part of the battery module.
Item 10. Hearing device according to Item 7 or Item 9, wherein the second part forms an outer surface of the hearing device.
Item 11. A method of assembling a hearing device comprising a hearing device module and a battery module, the method comprising:
   selecting the battery module from a set of battery modules comprising a first battery module and a second battery module, the first battery module configured to accommodate a disposable battery, and the second battery module comprising a rechargeable battery; and
   mounting the battery module to the hearing device module.
Item 12. Method according to Item 11, wherein mounting the battery module to the hearing device module comprises connecting a first supply terminal and a second supply terminal of the battery module to an electric interface of the hearing device module.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that the figures comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

2 hearing device
4 hearing device module
6 battery module
6A first battery module
6B second battery module
8 housing
8A end part of housing
10 frame
10A first frame of first part
10B second frame of second part
12 battery compartment
14 battery
14A rechargeable battery
14B single-use, disposable battery
16, 16A first part
18 electrical interface
19 printed circuit board, PCB, first PCB
19A printed circuit board assembly, PCBA, first PCBA
20 first power terminal
22 second power terminal
24 ground terminal
26 first control terminal
28 second control terminal
29 button
29A pin hole
30, 30A second part
31 electrical interface of battery module
32 first supply terminal
34 second supply terminal
36A first control terminal
36B second control terminal
38 printed circuit board, PCB, second PCB
38A printed circuit board assembly, PCBA, second PCBA
40 power module
42 first engagement member
43 second engagement member
44 first pin hole
45 second pin hole
46 first connector of first part
48 second connector of second part
50 first battery terminal
54 outer surface
56 pin connection
100 method of assembling a hearing device comprising a hearing device module and a battery module
S102 selecting the battery module
S104 mounting the battery module
S104A connecting a first supply terminal and a second supply terminal

1. A hearing device comprising a hearing device module and a battery module, the hearing device module comprising:
a housing forming at least a part of an outer surface of the hearing device;
a frame; and
a battery compartment;
wherein the battery module is in the battery compartment, the battery module comprising a plurality of parts including a first part configured to engage with the hearing device module for securing the battery module in the battery compartment.

2. The hearing device according to claim 1, wherein the battery module has a first battery module type, wherein the battery compartment is configured to alternatively receive the battery module of the first battery module type and another battery module of a second battery module type.

3. The hearing device according to claim 1, wherein the battery module comprises a first battery terminal and a second battery terminal.

4. The hearing device according to claim 1, wherein the first part comprises a first supply terminal and a second supply terminal for connecting to an electrical interface of the hearing device module.

5. The hearing device according to claim 4, the hearing device module comprising a printed circuit board, wherein the electrical interface is at the printed circuit board.

6. The hearing device according to claim 5, wherein the printed circuit board is attached to the frame.

7. The hearing device according to claim 4, wherein the electrical interface comprises a first power terminal for a first battery module type, and a second power terminal for a second battery module type.

8. The hearing device according to claim 1, wherein the battery module comprises a second part that is a battery door, and wherein the second part is rotatably coupled to the first part.

9. The hearing device according to claim 8, wherein the second part forms another part of the outer surface of the hearing device.

10. The hearing device according to claim 1, wherein the battery module comprises a rechargeable battery, and the first part of the battery module comprises a power module configured to apply a charging voltage to the rechargeable battery.

11. The hearing device according to claim 10, wherein the first part of the battery module comprises a first connector, and the battery module comprises a second part comprising a second connector configured to connect with the first connector for forming electrical and/or mechanical connection between the first part and the second part of the battery module.

12. The hearing device according to claim 11, wherein the second part forms another part of the outer surface of the hearing device.

13. A method of assembling a hearing device comprising a hearing device module and a battery module, the method comprising:
selecting the battery module from a set of battery modules comprising a first battery module and a second battery module, the first battery module configured to accommodate a disposable battery, and the second battery module comprising a rechargeable battery; and
mounting the battery module to the hearing device module.

14. The method according to claim 13, wherein the act of mounting the battery module to the hearing device module comprises connecting a first supply terminal and a second supply terminal of the battery module to an electric interface of the hearing device module.

15. The method according to claim 14, the hearing device module comprising a printed circuit board, wherein the electrical interface is at the printed circuit board.

16. The method according to claim 15, wherein the printed circuit board is attached to a frame of the hearing device.

17. The method according to claim 14, wherein the electrical interface comprises a first power terminal for a first battery module type, and a second power terminal for a second battery module type.
